(19) United States
(12) Patent Application Publication
(10) Pub. No.: US 2025/0325999 A1
(43) Pub. Date: Oct. 23, 2025

(54) TREATMENT PLANT FOR TREATING WORKPIECES, AND METHOD FOR TREATING WORKPIECES

(71) Applicant: Dürr Systems AG, Bietigheim-Bissingen (DE)

(72) Inventors: Sören WEHLER, Bönnigheim (DE); Michael JUST, Sindelfingen (DE); Meinhard LUTSCH, Ehningen (DE)

(21) Appl. No.: 18/861,817

(22) PCT Filed: Jun. 1, 2023
(86) PCT No.: PCT/DE2023/100415

§ 371 Date: Oct. 30, 2024

(30) Foreign Application Priority Data
Jun. 8, 2022 (DE) 10 2022 114 424.0

(51) Int. Cl. B05B 13/02; B05B 16/20; B05D 7/00

(52) U.S. Cl. CPC B05B 13/0221; B05B 16/20; B05D 7/534

(57) ABSTRACT

The present invention relates to a treatment plant (100) for treating workpieces, in particular for coating vehicle bodies, wherein the treatment plant (100) comprises the following: —a plurality of treatment levels (104, 106) which are arranged at different heights, in particular one above another; and/or—one or more treatment lines (110) which are arranged in particular parallel to one another and comprise a plurality of treatment regions (112, 114) arranged on one or more treatment levels (104, 106); wherein each treatment region (112, 114) has one or more treatment stations (118, 120, 122, 124, 126, 128, 136, 138, 140) for carrying out one or more treatment steps in each case, and wherein each treatment line (110) has one or at least two transfer conveying devices (142, 144, 152, 154), by means of which the workpieces are transferable between the treatment regions (112, 114). The present invention also relates to a method for treating workpieces, in particular for coating vehicle bodies, wherein the method comprises the following: —treating the workpieces in a plurality of treatment regions (112, 114) of a treatment line (110), in particular in a primary and a secondary treatment region (112, 114), which each have one or more treatment stations (118, 120, 122, 124, 126, 128, 136, 138, 140) for carrying out one or more treatment steps in each case.

### RELATED APPLICATION

This application is a national phase of international application No. PCT/DE2023/100415 filed on Jun. 1, 2023, and claims the benefit of German application No. 10 2022 114 424.0 filed on Jun. 8, 2022, which are incorporated herein by reference in their entirety and for all purposes.

### FIELD OF DISCLOSURE

The present disclosure relates to a treatment plant for treating workpieces, in particular for coating vehicle bodies. The treatment plant is thus in particular part of a paintshop for painting vehicle bodies. Furthermore, the disclosure relates to a corresponding method for treating workpieces.

### BACKGROUND

Increasingly often in practice, plants are used which allow a more individual and variant-rich paint application. For example, in addition or partially alternatively to regular topcoats, decor coats may be applied. A decor coat application may be integrated in a standard painting plant in various ways, wherein the standard painting plant usually has multiple treatment levels and/or intermediate levels.

A first possibility for such integration is an in-line process integration in which the decor coat application is fully integrated in a standard topcoat process. The station provided for the topcoat application is for example one station out of multiple stations which are arranged in a defined sequence, one behind the other in a conveying direction. In detail, after application of the basecoat, and in some cases a subsequent intermediate drying of the respective workpiece in an intermediate drying station, the decor coat application takes place on the same treatment level. After the decor coat application therefore, an additional intermediate drying station is required. Then a clearcoat may be applied. This first possibility for integrating a decor coat station is preferably selected for “greenfield” sites, i.e. in a new installation of a treatment plant, since in principle all stations can still be arranged freely.

In a second possibility, integration involves an off-line process in which, for application of the decor coat, the vehicle body is extracted from the process, in particular after application of the basecoat with subsequent drying in an intermediate drying station, which is known as “transfer out”. The decor coat may thus be applied e.g. on another treatment level of the painting plant from that of the standard topcoat process. In off-line process integration too, an additional intermediate drying station is required after application of the decor coat. After the intermediate drying of the vehicle body in the transfer-out region, this is returned to the standard topcoat process upstream of the clearcoat station, which is known as “transfer in”. Such an option for integration of a decor coat application is suitable for “brownfield” sites, i.e. on integration into an existing plant in which an alteration, or direct integration in the standard topcoat process, is no longer possible or disproportionately costly and complex.

A third and a fourth possibility of decor coat application require single-layer topcoat application, also called “mono layer coat” or “monocoat” in brief, and also involve off-line process integration.

In the case of the third option, the vehicle body is firstly fully painted and dried. Then the vehicle body is transported into a so-called overspray-free paint application booth or station (OFLA booth or OFLA station) where it receives the corresponding monolayer coat. This process requires no additional intermediate drying station after the decor coat application, but a new, separate drying station.

In the fourth possibility, the decor coat and clearcoat are applied together in the OFLA station, wherein here too, the vehicle body is transported into a separate OFLA station or OFLA line after completion of the standard topcoat process. This process option also requires an additional intermediate drying station after the decor coat application, and a further clearcoat drying station after the clearcoat application.

To summarize, it can be found that the decor coat application in an OFLA station has previously only been integrated in the painting process when the entire topcoat process is formed as a line, wherein it is known that the OFLA station is often arranged on the same level as the topcoat process. If an OFLA station in which a decor coat is applied must or should be self-contained, an additional intermediate drying station and in some cases a clearcoat drying station are required.

Thus multiple or additional intermediate drying stations and/or clearcoat drying stations are required, wherein not only is the surface area required large, or larger than in other plants, but also the control processes are more sophisticated and the energy consumption of such a painting plant rises or is increased.

### SUMMARY

Examples disclosed herein are based on the object of providing a treatment plant which allows a simple and compact process integration of a decor coat application.

This object is achieved according to examples disclosed herein by a treatment plant with the features of claim 1.

The treatment plant serves for treating workpieces. In particular, the treatment plant is a painting plant for coating vehicle bodies.

The treatment plant preferably comprises the following:
a plurality of treatment levels which are arranged at different heights, in particular one above another; and/or
one or more treatment lines which are arranged in particular parallel to one another and comprise a plurality of treatment regions arranged on one or more treatment levels;
   wherein each treatment region has one or more treatment stations for carrying out one or more treatment steps in each case, and wherein each treatment line has one or at least two transfer conveying devices, by means of which the workpieces are transferable between the treatment regions.

Examples disclosed herein are based on the concept that in a treatment plant, in particular a painting plant for vehicle bodies, in which the treatment of workpieces i.e. in particular vehicle bodies takes place on one or more levels, existing and unused plant space is utilized in order in particular to integrate an OFLA station for a decor coat application in the topcoat process. For example, this unused space is situated between the filter device of the basecoat station and the clearcoat station, wherein these filter plants are preferably arranged on the level below the level of the topcoat process. The topcoat process level is also called the topcoat level or TC level. Accordingly, after the intermediate drying station on the TC level, the workpieces may be conveyed by means of a transfer conveying device into the processing region in which the decor coat is applied. As already stated, this processing region is preferably situated below the TC level, wherein the workpieces are conveyed through the stations provided for the decor coat application on the other or lower level in the opposite direction to the conveying direction of the TC level. After the decor coat application, the workpieces are then conveyed by means of a further transfer conveying device to the TC level or into the topcoat process, preferably before its intermediate drying station so that no additional intermediate drying station need be provided after the decor coat application, but that of the topcoat process can be utilized, in some cases multiple times if multiple decor coat layers are desired or required for the respective workpiece.

Alternatively, a transfer may also be provided between the treatment regions with just one transfer conveying device, in particular if, by means of the one transfer conveying device, a transfer can take place in both directions between one or more different positions of the one treatment region and one or more different positions of the further treatment region.

It may be advantageous if a treatment line has a primary treatment region with a primary conveying direction and a secondary treatment region with a secondary conveying direction.

Preferably, the primary treatment region corresponds to the topcoat process region, while the secondary treatment region preferably comprises a decor coat station, in particular an OFLA station.

It may furthermore be provided that the primary treatment region has a primary horizontal conveying device for conveying the workpieces in the primary conveying direction, and that the secondary treatment region has a secondary horizontal conveying device for conveying the workpieces in the secondary conveying direction.

The horizontal conveying devices may be conveyor lines, wherein the workpieces to be treated may each be mounted on a skid which is conveyed through the treatment regions. Alternatively, one or more skid-free conveying devices may be provided locally or globally.

In particular, it may be advantageous if the primary horizontal conveying device and/or the secondary horizontal conveying device comprise or are formed by driverless transport vehicles and/or transport systems.

The primary horizontal conveying device and the secondary horizontal conveying device may be different types of horizontal conveying device. It may however be advantageous if the primary horizontal conveying device and the secondary horizontal conveying device are formed by the same type of horizontal conveying device, e.g. by roller conveyors, rail conveyors or a driverless transport system.

It may be advantageous if the primary conveying direction and the secondary conveying direction are oriented opposite and preferably at least approximately parallel to one another. In particular, the conveying directions are oriented antiparallel to one another.

In this way, workpieces which are transferred back from the secondary treatment region to the primary treatment region are integrated at a position of the primary treatment region such that they pass again through at least one treatment station of the primary treatment region.

It may be particularly advantageous if the workpieces are transferable from the secondary treatment region to the primary treatment region by means of a first transfer conveying device, and if the workpieces are transferable from the primary treatment region to the secondary treatment region by means of a second transfer conveying device.

Because of the two transfer conveying devices, preferably a circular conveying of the workpieces is possible in which preferably the workpieces pass through the entire secondary treatment region at least once, and through at least portions of the primary treatment region, i.e. at least one treatment station of the primary treatment region, multiple times, preferably twice.

It may be advantageous if the workpieces are conveyable through the secondary treatment region in the same orientation as in the primary treatment region.

It may be particularly advantageous if the workpieces need not be rotated about the vertical axis in order to be transferred between the treatment regions by transfer conveying devices.

In particular, it may be provided that the workpieces are conveyable through the secondary treatment region backwards relative to the primary conveying direction.

It may be advantageous if the primary treatment region has at least the following treatment stations arranged after one another in the primary conveying direction:
a basecoat station;
optionally a flash-off station;
an intermediate drying station;
optionally a cooling station;
a clearcoat station; and
a drying station.

The flash-off station is optional because the position of the transfer conveying device before the intermediate drying station, which would otherwise be passed over, may also be used for flash-off as long as the process phasing does not require the conveying of any workpiece from the secondary treatment region to the primary treatment region.

The cooling station is optional because cooling is also conceivable within the intermediate drying station.

Furthermore, the provision of a flash-off station and/or a cooling station is dependent on the specifications of the paint supplier or the requirements of the paint used.

It may be favorable if the secondary treatment region has at least the following treatment stations arranged after one another in the secondary conveying direction:
optionally an intermediate storage station, in particular a first intermediate storage station;
a topcoat station, in particular an overspray-free topcoat station;
a flash-off station; and
optionally an intermediate storage station, in particular a second intermediate storage station.

It should be understood that the listed treatment stations of the secondary treatment region may also be arranged in a different order in the secondary conveying direction. The list should not therefore be regarded as the only possible order of the treatment stations. The same applies accordingly to the treatment stations in the primary treatment region.

One or more intermediate storage stations, in particular the first and/or the second intermediate storage stations, serve for example as buffers in the process cycle. Alternatively or additionally, it may be provided that one or more intermediate storage stations, in particular the second intermediate storage station, is or can be used as a flash-off station.

It may furthermore be provided that in the primary treatment region, the first transfer conveying device is arranged between the basecoat station and the intermediate drying station, and the second transfer conveying device is arranged between the intermediate drying station and the clearcoat station.

It may furthermore be provided that in the secondary treatment region, the first transfer conveying device is arranged after the topcoat station and/or after an intermediate storage station, in particular a second intermediate storage station.

The second transfer conveying device is preferably arranged in the secondary treatment region before the topcoat station and/or before an intermediate storage station, in particular a first intermediate storage station.

The workpieces are thus conveyable multiple times through the intermediate drying station and/or the cooling station.

Thus advantageously, the intermediate drying station of the primary treatment region is usable multiple times, which means that preferably no additional intermediate drying station is required for the secondary treatment region. As a result, preferably costs and plant space can be saved, and also the decor coat application can easily be integrated in an existing primary treatment region, in particular a standard topcoat process.

In a further embodiment of examples disclosed herein, it may be provided that the secondary treatment region is arranged on a treatment level below or above a treatment level of the primary treatment region, wherein the first and the second transfer conveying devices are preferably vertical conveying devices.

In a further embodiment of examples disclosed herein, it may be provided that the secondary treatment region is arranged on a lowest treatment level, in particular a zero level.

Such an arrangement of the secondary treatment region which comprises the decor coat station is preferably possible because the decor coat application preferably takes place overspray-free, and thus no wash-out or other air cleaning below the decor coat station is required.

In a further embodiment of examples disclosed hereinn, it may be provided that the primary treatment region and the secondary treatment region are arranged next to one another on one treatment level, wherein the first transfer conveying device and the second transfer conveying device are preferably transverse conveying devices.

Such an arrangement offers an alternative if not enough plant space is available below or above the primary treatment region, in particular at the level of the intermediate drying station and cooling station, for equipping or adapting the secondary treatment region.

The present disclosure is furthermore based on the object of providing a method which allows use and efficient operation of a simple and compactly constructed treatment plant.

This object is achieved according to examples disclosed herein by a method according to the independent method claim.

The method is in particular a method for treating workpieces, in particular for painting vehicle bodies.

The method may in particular have individual or multiple features and/or advantages described in connection with the treatment plant.

Preferably, the method comprises the following:
treating the workpieces in a plurality of treatment regions of a treatment line, in particular in a primary and a secondary treatment region, which each have one or more treatment stations for carrying out one or more treatment steps in each case.

In a further embodiment of examples disclosed herein, it may be provided that the method furthermore comprises the following:
transferring the workpieces between the treatment regions, wherein the treatment regions are arranged on one or more treatment levels of a treatment plant, and/or wherein the treatment regions have opposing conveying directions.

It may be favorable if the workpieces are conveyed multiple times, in particular at least twice, through at least one of the treatment regions.

It may furthermore be advantageous if the primary treatment region has an intermediate drying station, after which the workpieces are transferred into the secondary treatment region by means of a transfer conveying device, and if the workpieces are transferred from the secondary treatment region back into the primary treatment region before the intermediate drying station, by means of a further transfer conveying device.

It may furthermore be provided that, on transfer between the treatment regions, the workpieces are not changed in their orientation, in particular not rotated. An orientation of the workpieces relative to a main conveying direction of the treatment plant thus preferably remains unchanged throughout the entire treatment in the primary and in the secondary treatment regions, and furthermore also during transfer between the treatment regions.

Further preferred features and advantages of examples disclosed herein are the subject of the following description and the illustration of exemplary embodiments in the drawings.

### BRIEF DESCRIPTION OF THE DRAWINGS

FIG. 1 a schematic illustration of a first embodiment of a treatment plant according to examples disclosed herein;

FIG. 2 a schematic illustration of a second embodiment of the treatment plant according to examples disclosed herein; and

FIG. 3 a schematic illustration of a third embodiment of the treatment plant according to examples disclosed herein.

The same or functionally equivalent elements carry the same reference signs in all figures.

### DETAILED DESCRIPTION OF THE DRAWINGS

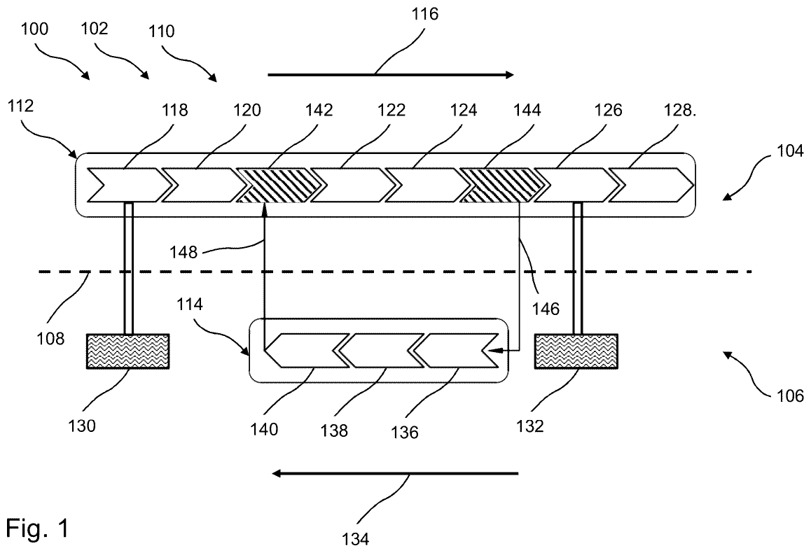

A first embodiment of a treatment plant, designated as a whole as 100 and illustrated in FIG. 1, serves for the treatment of workpieces.

The treatment plant 100 is in particular a painting plant 102 for painting vehicle bodies.

The treatment plant 100 comprises a primary treatment level 104 and a secondary treatment level 106, which are arranged one above the other.

The horizontal dotted line marked with 108 represents, for example schematically, the floor of the primary treatment level 104 and/or the ceiling of the secondary treatment level 106 lying below this.

The treatment plant 100 furthermore comprises a treatment line 110.

It is possible that the treatment plant 100 comprises multiple treatment lines which are preferably arranged parallel to the illustrated treatment line 110.

The treatment line 110 comprises a primary treatment region 112 which is arranged on the primary treatment level 104, and a secondary treatment region 114 which is arranged on the secondary treatment level 106.

The primary treatment region 112 comprises, successively in a primary conveying direction 116, a basecoat station 118, a flash-off station 120, an intermediate drying station 122, a cooling station 124, a clearcoat station 126 and a drying station 128.

The flash-off station 120 and the cooling station 124 are optional in the primary treatment region 112, since their use depends inter alia on the specifications of the paint supplier.

In the embodiment of a treatment plant 100 shown in FIG. 1, a filter device 130 of the basecoat station 118, and a further filter device 132 of the clearcoat station 126, are arranged below the primary treatment region 112 on the secondary treatment level 106, preferably directly vertically below the basecoat station 118 and the clearcoat station 126 respectively.

It is however also possible to arrange the filter device 130 and/or the filter device 132 above the primary treatment region 112, or alternatively on the primary treatment level 104.

A basecoat is applied to the workpieces in the basecoat station 118, while a clearcoat is applied to the workpieces in the clearcoat station 126.

The basecoat application in the basecoat station 118 may take place in line or in a box. The same applies to the clearcoat application in the clearcoat station 126.

The primary treatment region 112 furthermore comprises a horizontal conveying device (not shown), via which the workpieces can be conveyed through the primary treatment region 112 along the primary conveying direction 116.

The horizontal conveying device may for example be a roller conveyor, a rail conveyor or a driverless transport system.

The secondary treatment region 114 is preferably arranged in the space available between the filter device 130 and a filter device 132.

Alternatively, the secondary treatment region 114 may be arranged below the intermediate drying station 122 and/or the cooling station 124.

The secondary treatment region 114 comprises, successively in a secondary conveying direction 134, an optional extra intermediate storage station 136, a decor coat station 138, and an optional second intermediate storage station 140, wherein the order of the first intermediate storage station 136, decor coat station 138 and second intermediate station 140 in the secondary conveying direction 134 is arbitrary.

It is furthermore possible that an optional (further) flash-off station is arranged between the decor coat station 138 and the second intermediate storage station 140.

Also, it may be provided that the first intermediate storage station 136 and/or the second intermediate storage station 140 are not only used for preferably brief temporary storage of the workpieces, so that the workpieces can easily be phased into the predefined process cycle, but can also serve as a flash-off station, in particular on reintegration into the primary treatment region 112.

In the decor coat station 138, a decor coat is applied to the workpieces, wherein the paint is applied preferably overspray-free or at least overspray-reduced. The decor coat station 138 is in particular a so-called OFLA station (overspray-free paint application station).

Alternatively, the decor coat may also be applied in conventional fashion, i.e. with so-called masking and de-masking using atomization technology.

In the embodiment of the treatment plant 100 shown in FIG. 1, the secondary treatment level 106 is preferably the zero level, in particular the so-called concrete level. This is possible in particular because the decor coat application in the form of an overspray-free paint application requires no wash-out underneath or other complex air cleaning.

Furthermore, a first vertical conveyor device 142 and a second vertical conveyor device 144, by means of which the workpieces are transferable between the primary and the secondary treatment regions 112, 114, are integrated in the primary and secondary treatment regions 112, 114 of the treatment line 110.

The second vertical conveying device 144 is arranged after the cooling station 124 and conveys the cooled workpieces vertically along a first vertical conveying line 146 to the secondary treatment level 106 before or into the first intermediate storage station 136.

If, process-dependently, the second vertical conveying device 144 is not required, the cooled workpieces may be conveyed directly into the clearcoat station 126 after the cooling station 124.

In the secondary treatment region 114, a horizontal conveying device (not shown) also conveys the workpieces through the treatment stations along the secondary conveying direction 134.

From the second intermediate storage station 140, or from a position after the second intermediate station 140, the workpieces provided with a decor coat are conveyed by means of the first vertical conveying device 142 along a second vertical conveying line 148 onto the primary treatment level 104 before the intermediate drying station 122, in order then, in the next conveying cycle, to dry the decor coat in this intermediate drying station 122.

The intermediate drying station 122 is preferably designed for the resulting increased workpiece through-flow.

The multiple, in particular double, use of the intermediate drying station 122 in the treatment of workpieces in the treatment line 110 not only saves room but also energy and hence costs.

Optionally, it may be provided that, starting from the primary treatment region 112, the workpieces can pass multiple times through the secondary treatment region 114. As a result, in particular highly complex decor coat applications can be achieved in a multilayer process.

The vertical conveying devices 142, 144 may be lifting devices, elevator devices or carousel conveying devices or similar, via which the workpieces can be conveyed individually in succession or continuously along the vertical conveying lines 146, 48.

The workpieces are preferably secured against falling during transport along vertical conveying lines 146, 148.

It may furthermore be provided that one of the vertical conveying devices 142, 144, or both vertical conveying devices 142, 144, have additional ventilation.

The vertical end position of the first vertical conveying device 142 before the intermediate drying station 122, which the workpieces treated in the primary treatment region 112 pass over, may replace the flash-off station 120 as a separate flash-off station, wherein this depends in particular on what flash-off time is necessary for the basecoat applied in the basecoat station 118, in order to reduce the solvent input in the intermediate drying station 122.

The starting position of the second vertical conveying device 144 after the cooling station 124, which the workpieces pass over to reach the clearcoat station 126, can also be used as a flash-off station and/or intermediate storage station.

The decor coat station 138 on the secondary treatment level 106 is preferably arranged below the intermediate drying station 122 and/or the cooling station 124, in particular directly below the intermediate drying station 122 and/or cooling station 124 in the vertical direction.

The workpieces, which are conveyed by means of the first and second vertical conveying devices 142, 144 from the first processing region 112 into the second processing region 114 and back, do not change their orientation during transport. This means in particular that no rotation about the vertical axis of the workpiece is required in order to be conveyable along the vertical conveying lines 146, 148, and that also the workpieces can travel backwards through the secondary treatment region 114 in the secondary conveying direction 134.

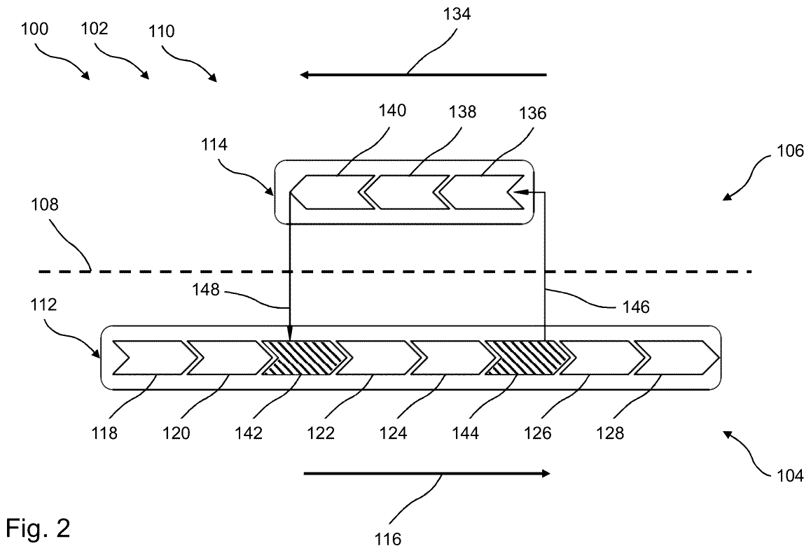

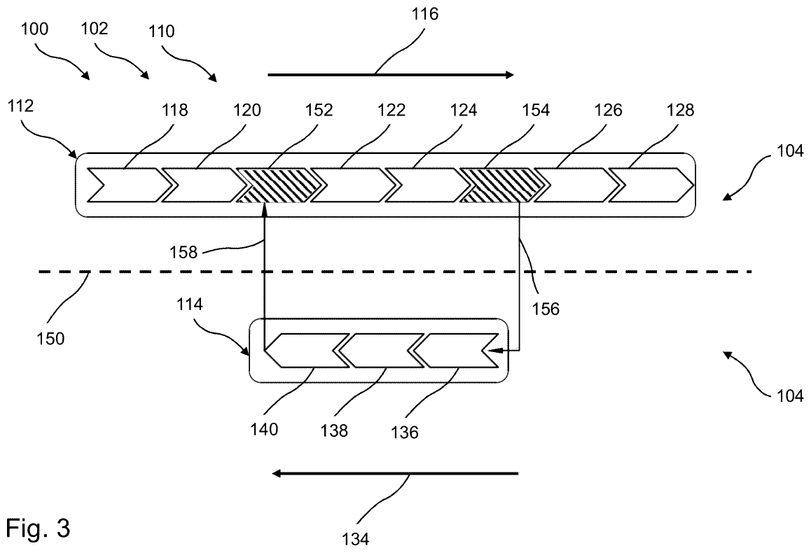

The process of treating workpieces, in particular painting vehicle bodies, is described below as an example with reference to the embodiment of the treatment plant 100 from FIG. 1, wherein the description of the treatment process applies accordingly to the second and third embodiments in FIGS. 2 and 3.

A workpiece, in particular a vehicle body, which is conveyed by means of a horizontal conveying device through the primary treatment region 112 in the primary conveying direction 116, first receives a basecoat in the basecoat station 118, wherein greasing and phosphatizing may take place before the basecoat application.

Then the workpiece with basecoat is flash-dried, also known as “flash-off”. This takes place either in the flash-off station 120 or at the position of the first vertical conveying device 142 before the intermediate drying station 122.

After flash-off, the workpiece is dried in the intermediate drying station 122 and then cooled in the cooling station 124.

Following the cooling process, i.e. in the position before the clearcoat station 126, the workpiece to be treated is conveyed, by means of the second vertical conveying device 144, along the vertical conveying line 146 from the primary treatment level 104 into the secondary treatment level 106, in order there to pass through the secondary treatment region 114 in the second conveying direction 134, which is opposite to the primary conveying direction 116.

There the workpieces may initially be temporarily stored in a first intermediate storage station 136, wherein both the first intermediate storage station 136 and also the second intermediate storage station 140 may, as part of the process cycle, simplify the extraction and integration of workpieces from and into the primary processing region 112.

Then the decor coat is applied to the workpieces in a decor coat station 138, preferably in an overspray-free process.

The workpiece may flash-off either in an additional flash-off station or in the second intermediate storage station 140, before it is conveyed along the second vertical conveying line 148 by means of the first vertical conveying device 142 to before the intermediate drying station 122, in order to pass through this again and thus dry the applied decor coat.

The re-dried workpiece is cooled again in the cooling station 124 and then, i.e. at the end of the cooling cycle, conveyed to the clearcoat station 126, provided that no second decor coat layer is to be applied.

If a second or further decor coat layer is to be applied to the workpiece, it must pass through the secondary processing region 114, the intermediate drying station 122 and the cooling station 124 again.

A clearcoat is then applied to the workpiece in the clearcoat station 126, and then the fully painted workpiece is preferably completely dried in a drying station 128.

The second embodiment, illustrated in FIG. 2, of a treatment plant 100 according to examples disclosed herein differs from the first embodiment in FIG. 1 in that the secondary treatment region 114 of the treatment line 110 is arranged above the primary treatment region 112 of the treatment line 110, i.e. the secondary treatment level 106 of the treatment plant 100 is in this case situated above the primary treatment level 104.

The sequence of the treatment process however remains unchanged, except that after the cooling station 124, the workpieces are conveyed by means of the second vertical conveying device 144 along the first vertical conveying line 146 from the primary treatment level 104 upward onto the second treatment level 106, in order there to pass in the secondary conveying direction 134 through the secondary treatment region 114, at the end of which they are conveyed back along the second vertical conveying line 148 downward onto the primary treatment level 104. There, they pass through the intermediate drying station 122 and optionally the cooling station 124 of the primary treatment region 112 again.

Such an arrangement of the treatment plant 100 is possible inter alia because, thanks to the absence of overspray, the decor coat application in the decor coat station 138 of the secondary treatment region 114 requires no wash-out arranged below the decor coat station 138, or other complex air cleaning.

It is conceivable that, between the primary treatment level 104 and the secondary treatment level 106, an intermediate level is arranged in which support modules or support equipment, such as wash-out devices or filter devices, necessary for the stations of the secondary treatment region 114, can be arranged.

FIG. 3 shows a third embodiment of the treatment plant 100, in which the primary treatment region 112 and the secondary treatment region 114 of the treatment line 110 are arranged on a common, in particular primary treatment level 104. Accordingly, instead of two vertical conveying devices, the treatment line has a first transverse conveying device 152 and a second transverse conveying device 154, in order to transfer the workpieces accordingly between the primary and secondary treatment regions 112, 114.

The dotted horizontal line 150 in FIG. 3 marks a real or virtual spatial separation between the primary treatment region 112 and the secondary treatment region 114 on the primary treatment level 104.

In the third embodiment, after the cooling station 124, the workpieces are conveyed by a second transverse conveying device 154 along a first transverse conveying line 156 into the secondary treatment region 114 of the treatment line 110, in order there to receive the decor coat application in the decor coat station 138.

Following the decor coat application and a possible temporary storage in the second intermediate storage station 140, the workpieces are conveyed by means of the first transverse conveying device 152 along a second transverse conveying line 158 back into the primary treatment region 112 on the same level, in particular the primary treatment level 104. There, they are returned to the topcoat process of the primary treatment region 112 before the intermediate drying station 122, in order to pass through the intermediate drying station 122 and the cooling station 124 again before the application of a clearcoat in the clearcoat station 126.

It is conceivable that multiple treatment lines 110 according to the embodiment shown in FIG. 3, i.e. with transverse conveying on one treatment level, are arranged in the treatment levels arranged above one another of the treatment plant 100.

### LIST OF REFERENCE SIGNS

100 Treatment plant
102 Painting plant
104 Primary treatment level
106 Secondary treatment level
108 Level floor/ceiling
110 Treatment line
112 Primary treatment region
114 Secondary treatment region
116 Primary conveying direction
118 Basecoat station
120 Flash-off station
122 Intermediate drying station
124 Cooling station
126 Clearcoat station
128 Drying station
130 Filter device of basecoat station
132 Filter device of clearcoat station
134 Secondary conveying direction
136 First intermediate storage station
138 Decor coat station
140 Second intermediate storage station
142 First vertical conveying device
144 Second vertical conveying device
146 First vertical conveying line
148 Second vertical conveying line
150 (Virtual) spatial separation
152 First transverse conveying device
154 Second transverse conveying device
156 First transverse conveying line
158 Second transverse conveying line

1. A treatment plant for treating workpieces, in particular optionally for coating vehicle bodies, the treatment plant comprising:
a plurality of treatment levels which are arranged at different heights, in particularoptionally one above another; and/or
one or more treatment lines which are arranged optionally parallel to one another and comprise include a plurality of treatment regions arranged on one or more treatment levels;
wherein each treatment region has one or more treatment stations for carrying out one or more treatment steps in each case, and wherein each treatment line has one or at least two transfer conveying devices, by which the workpieces are transferable between the treatment regions.

2. The treatment plant as claimed in claim 1, wherein a treatment line has a primary treatment region with a primary conveying direction and a secondary treatment region with a secondary conveying direction.

3. The treatment plant as claimed in claim 2, wherein the primary treatment region has a primary horizontal conveying device for conveying the workpieces in the primary conveying direction, and wherein the secondary treatment region has a secondary horizontal conveying device for conveying the workpieces in the secondary conveying direction.

4. The treatment plant as claimed in claim 3, wherein the primary horizontal conveying device and/or the secondary horizontal conveying device are formed by the same type of conveying device, in particular optionally by roller conveyors, rail conveyors or a driverless transport system.

5. The treatment plant as claimed in claim 2, wherein the primary conveying direction and the secondary conveying direction are oriented opposite and preferably at least approximately parallel to one another.

6. The treatment plant as claimed in claim 2, wherein the workpieces are transferable from the secondary treatment region to the primary treatment region by a first transfer conveying device, and wherein the workpieces are transferable from the primary treatment region to the secondary treatment region by a second transfer conveying device.

7. The treatment plant as claimed in claim 2, wherein the workpieces are conveyable through the secondary treatment region in the same orientation as in the primary treatment region.

8. The treatment plant as claimed in claim 2, wherein the workpieces are conveyable through the secondary treatment region backwards relative to the primary conveying direction.

9. The treatment plant as claimed in claim 2, wherein the primary treatment region has at least the following treatment stations arranged after one another in the primary conveying direction:
a basecoat station;
optionally a flash-off station;
an intermediate drying station;
optionally a cooling station;
a clearcoat station;
a drying station.

10. The treatment plant as claimed in claim 2, wherein the secondary treatment region has at least the following treatment stations arranged after one another in the secondary conveying direction:
a first intermediate storage station;
a topcoat station, in particular, optionally an overspray-free topcoat station;
a flash-off station;
a second intermediate storage station.

11. The treatment plant as claimed in claim 9, wherein in the primary treatment region, the first transfer conveying device is arranged between the basecoat station and the intermediate drying station, and the second transfer conveying device is arranged between the intermediate drying station and the clearcoat station, and
wherein in the secondary treatment region, the first transfer conveying device is arranged after the topcoat station and/or an optional second intermediate storage station, and the second transfer conveying device is arranged before the topcoat station and/or an optional first intermediate storage station,
so that the workpieces are conveyable multiple times through the intermediate drying station and/or the cooling station.

12. The treatment plant as claimed in claims 2, wherein the secondary treatment region is arranged on a treatment level below or above a treatment level of the primary treatment region, wherein the first and the second transfer conveying devices are preferably vertical conveying devices.

13. The treatment plant as claimed in claim 2, wherein the secondary treatment region is arranged on a lowest treatment level, optionally a zero level.

14. The treatment plant as claimed in claim 2, wherein the primary treatment region and the secondary treatment region are arranged next to one another on a common treatment level, wherein the first and the second transfer conveying devices are preferably transverse conveying devices.

15. A method for treating workpieces, optionally for coating vehicle bodies, the method comprising:
treating the workpieces in a plurality of treatment regions of a treatment line, optionally in a primary and a secondary treatment region, which each have one or more treatment stations for carrying out one or more treatment steps in each case.

16. The method as claimed in claim 15, the method further including:
transferring the workpieces between the treatment regions, wherein the treatment regions are arranged on one or more treatment levels of a treatment plant, and/or wherein the treatment regions have opposing conveying directions.

17. The method as claimed in claim 15, wherein the workpieces are conveyed multiple times, optionally at least twice, through at least one of the treatment regions, optionally a portion of the first treatment region.

18. The method as claimed in claims 15, wherein the primary treatment region has an intermediate drying station, after which the workpieces are transferred into the secondary treatment region by a transfer conveying device, and
wherein the workpieces are transferred from the secondary treatment region back into the primary treatment region before the intermediate drying station by a further transfer conveying device.

19. The method as claimed in claim 15, wherein on transfer between the treatment regions, the workpieces are not changed in their orientation, optionally not rotated.
